(19) United States
(12) Patent Application Publication
(10) Pub. No.: US 2003/0207638 A1
(43) Pub. Date: Nov. 6, 2003

(54) Electroprocessing polymers to form footwear and clothing

(76) Inventors: Gary L. Bowlin, Mechanicsville, VA (US); David G. Simpson, Mechanicsville, VA (US); Gary Wnek, Midlothian, VA (US)

Correspondence Address: John H. Thomas, P.C., 1561 East Main Street, Richmond, VA, 23219, US

(21) Appl. No.: 10/407,198

(22) Filed: Apr. 7, 2003

Related U.S. Application Data
(63) Continuation-in-part of application No. 09/714,255, filed on Nov. 17, 2000.
(60) Provisional application No. 60/240,965, filed on Oct. 18, 2000.

(30) Foreign Application Priority Data
Oct. 18, 2001 (WO) PCT/US01/32519

(51) Int. Cl. B32B 25/10; D04H 1/00; B32B 27/40

(52) U.S. Cl. 442/329; 442/399; 428/423.1; 428/904; 428/913; 57/402

(57) ABSTRACT

Electroprocessed polymers are used to form specifically-shaped shoes, clothing or other related garments. A mandrel having a preselected shape is used as the target in the electroprocessing step. The resulting product has a polymer matrix of exactly the shape of the mandrel. In practice, a person's foot or other body part is used to create the predetermined shape.

This application claims the benefit of the filing date of U.S. Provisional Application Serial No. 60/240,965 filed on Oct. 18, 2000; and also U.S. application Ser. No. 09/714,255 filed on Nov. 17, 2000.

This invention relates to the electroprocessing of polymers to form footwear and other clothing products including manufactured leather.

### BACKGROUND OF THE INVENTION

Electrospinning has been used in the manufacture of fabric for many years. Electrospinning is an alternative method of making fabric to the known methods of weaving, knitting, conventional nonwovens, etc. However, the use of electrospinning has been primarily limited to flat sheets of fabric of synthetic polymer. The fabric is then cut and sewn like traditional fabrics.

The only way to achieve a form-fitting garment is to use an elastic material that achieves the fit through stretch of the material or to perform a potentially complicated cut and sew pattern. It has not been possible to achieve an exact form fit. Also, known electrospinning techniques mimic and are used to make thin fabrics, but have never been used to create a thicker material or to make any synthetic hide or leather product.

### SUMMARY OF THE INVENTION

The method of electroprocessing allows a custom shoe or piece of clothing to be made to exactly fit a form designed to mimic a human foot, hand, torso, etc. Electroprocessing may be used to create a thicker material that mimics leather by electroprocessing a natural polymer such as collagen. The electroprocessing method has great variability to allow many types of performance features to be engineered directly into a final product.

In one embodiment, a shoe having a predetermined shape comprises a matrix of polymer. The matrix is formed by electroprocessing the polymer onto a mandrel having the predetermined shape. The polymer may be comprised of a material that changes color in response to stretch and compression. That material may be a polyurethane containing polydiacetylene segments. The matrix may also further include piezoelectric material.

In a further embodiment, clothing having a predetermined shape comprises a matrix of polymer. The matrix is formed by electroprocessing the polymer onto a mandrel having the predetermined shape. The polymer may include a material that changes color in response to stretch and compression. That material may include a polyurethane containing polydiacetylene segments. The matrix may further comprise piezoelectric material.

In a further alternative embodiment, a manufactured leather comprises a matrix of electroprocessed collagen. The collagen may comprise electrospun collagen fibers or electrosprayed collagen droplets. The electroprocessed collagen may be subsequently cross-linked. Similarly, the invention includes a method of making manufactured leather comprising electroprocessing a matrix of collagen. That method may further include the step of treating the collagen matrix with a crosslinking agent.

### BRIEF DESCRIPTION OF THE DRAWINGS

FIG. 1 is a scanning electron micrograph of an electrospun matrix of fibers.

FIG. 2 is a scanning electron micrograph of the external surface of an electroaerosol PGA/PLA (50%/50%) matrix.

FIG. 3 is a scanning electron micrograph of a cross sectional view of an electroaerosol PGA/PLA (50%/50%) matrix.

FIG. 4 is a scanning electron micrograph of a cross sectional view of the electroaerosol PGA/PLA (50%/50%) matrix that is a higher magnification of the same construct as shown in FIG. 3.

FIG. 5 is a scanning electron micrograph of the luminal surface of an electroaerosol PGA/PLA (50%/50%) matrix as also shown in FIGS. 2-4.

FIGS. 6-11 are photographs of an electroprocessing apparatus and a foot-shaped mandrel target. The figures display an electroprocessed matrix already deposited on the mold.

FIGS. 12-14 are scanning electron micrographs of varying magnification of electroprocessed collagen to form leather.

FIGS. 15-17 are scanning electron micrographs of a matrix of collagen that has been electroprocessed and treated with a cross-linking agent to form leather.

### DETAILED DESCRIPTION OF THE INVENTION

A. Basic Information

Any type of polymer or combination of polymers may be used in the electroprocessing described herein. Natural polymers such as collagen, (leather), gelatin (denatured collagen), fibrin, fibronectin, elastin, fragments or segments thereof, synthetic polymers of natural materials, or others may be used. Conventional synthetic polymers such as polyethylene, nylon, polyesters, polyolefins, vinyl polymers, polyurethanes and polyamides may be used.

The present invention also envisions the use of biologically compatible, synthetic polymers in building the electroprocessed matrix. These polymers include the following: poly(urethanes), poly(siloxanes) or silicones, poly(ethylene), poly(vinyl pyrrolidone), poly(2-hydroxy ethyl methacrylate), poly(n-vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), polylactides (PLA), polyglycolides (PGA), poly(lactide-co-glycolides) (PLGA), polyanhydrides, and polyorthoesters. Different combinations, mixtures, or copolymers of all of these polymers may also be used to obtain desired end product attributes or to meet necessary processing parameters. The use of these polymers will depend on given applications and specifications required. A more detailed discussion of the biologically compatible, synthetic polymers is set forth in Brannon-Peppas, Lisa, “Polymers in Controlled Drug Delivery,” Medical Plastics and Biomaterials, November 1997, which is incorporated by reference as if set forth fully herein.

B. Electroprocessed Matrices

1. Process Variations

The term “electroprocessing” shall be used broadly to cover the methods of electrospinning of fibers, electrospraying (electroaerosoling) of droplets, combinations of electrospinning and electroaerosoling, and any other method where a polymer is streamed across an electric field. The solution being streamed may be charged and directed to a grounded substrate. Similarly, the solution may be streamed from a grounded reservoir in the direction of a charged substrate. The term “electroprocessing”, therefore, is not limited to the specific examples set forth herein.

Throughout this application, the term “solution” is used to describe the liquid in the reservoir of the electroprocessing method. This could imply that the polymer is fully dissolved in the liquid. In this application, the term “solution” also refers to suspensions when the polymer is not soluble (or only partially soluble) in the liquid used in a given process. This broad definition is appropriate in view of the large number of solvents or other liquids that may be used in the many variations of electroprocessing. Melt electroprocessing may also be used provided that the temperature used to do so does not degrade the substances to be delivered. There are many different applications for electroprocessed polymer. The versatility is enabled by the variability of the process itself. Generally speaking, there is variability with the equipment used, the solution that is streamed in the process, and various post-process treatments.

In the most fundamental sense, the electroprocessing apparatus includes a streaming mechanism and a target substrate. The streaming mechanism will include a reservoir or reservoirs to hold the solution that is to be streamed in the process. The reservoir or reservoirs have at least one orifice or nozzle to allow the streaming of the solution from the reservoirs. There may be a single nozzle or there may be multiple nozzles in a given electroprocessing apparatus. If there are multiple nozzles, they may be attached to one or more reservoirs containing the same or different solutions. Similarly, there may be a single nozzle that is connected to multiple reservoirs containing the same or different solutions. Also, the size of the nozzle may be varied to provide for increased or decreased flow of the solution out of the reservoir through the nozzle. A pump used in connection with the reservoir may be used to control the flow of solution streaming from the reservoir through the nozzle or nozzles. The pump may be programmed to increase or decrease the flow at different points during an electroprocessing run.

When different reservoir sources are used, the system can be designed to allow the different reservoirs to function simultaneously or independently of one another. This allows different materials to be delivered to the target site at the same time or at different times to produce distinct layers of materials. The source reservoirs can also be designed to allow polymers to mix in mid-stream prior to deposition on the target site. These processes allow the resulting product to have very unique properties. For example, electrospun leather gloves can be designed to have areas in the fingers that are enriched in elastic compounds that provide traction or cushioning. The advantage is the transition between the leather and the elastic compound can be seamless and continuous in nature. Unlike a conventional glove, the elastic component can be literally blended with the leather as the leather is laid down. If desired, the elastic component of the glove could be laid down as a distinct layer, this might have fashion or performance advantages in some applications of the process. Another example is the fabrication of a glove with attributes unavailable with natural leather—for example, water resistance that is the result of blending rubber or other compounds into the collagen reservoir that is used for electrospinning.

The target substrate may also be used as a variable feature in the electroprocessing of polymers. Specifically, the target may be the actual substrate onto which the polymers are deposited. Alternatively, a substrate may be disposed between the target and the nozzle, for instance, a nonstick surface between the nozzle and target. The target may also be specifically charged (grounded) along a preselected pattern so that the polymer streamed from the orifice is directed into specific directions. Ideally, the electric field is controlled by a program to create a matrix having a desired geometry. The target and the nozzle or nozzles may be engineered to be movable with respect to each other thereby allowing additional control over the geometry of the matrix to be formed. It is envisioned that the entire process will be controlled by a microprocessor that is programmed with the specific parameters to obtain a specific, preselected electroprocessed matrix of polymer.

Also, as noted in the specific examples that follow, the nozzle or orifice that allows streaming of solution from the reservoir is shown to be charged and the target is shown to be grounded. Those of skill in the electroprocessing arts will recognize that the nozzle and solution may be grounded and the target may be electrically charged. In any event, it is the creation of the electric field and the effect of the electric field on the streamed polymer that helps create the unique polymer matrix.

In addition to the multiple equipments and variations and modifications that can be made to obtain desired results, similarly the solution can be varied to obtain different results. For instance, the solvent or liquid in which the polymer is dissolved or suspended may be varied. The polymer can be mixed with other polymers to obtained desired end results. In still a further variation, when multiple reservoirs are used, the ingredients in those reservoirs may be electrosprayed separately or joined at the nozzle so that the ingredients in the various reservoirs may react with each other simultaneously with the streaming of the solution into the electric field. Also, when multiple reservoirs are used, the different ingredients in different reservoirs may be phased in over time in the processing period. Also, other materials may be attached to the polymer before, during or after electroprocessing. Further, the temperature and other physical properties of the process can be modified to obtain different results.

Finally, there are many types of post-process treatments that may be used to modify and adjust the matrix that is the result of the electroprocessing procedure. For instance, a matrix of electroprocessed polymer may be treated with a cross linking agent, including chemical and UV-light based cross-linking agents. Also, the matrix may be treated with variations in temperature. Still further chemical variations may be envisioned by those desiring specific end properties of a matrix.

2. Examples

Electrospun Matrix

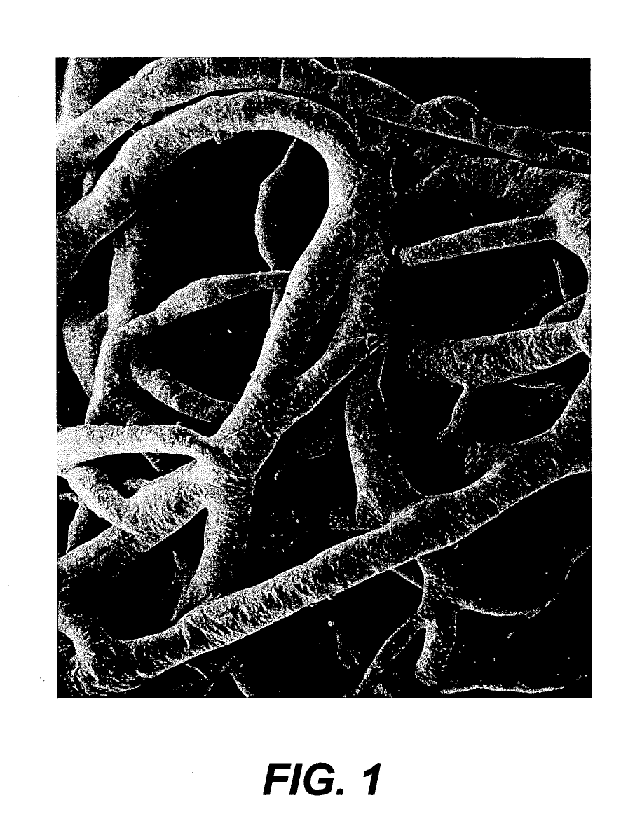

A matrix was made of poly-lactic/poly-glycolyic acid (PLA/PGA; 50/50—RESOMER® RG 503, Boehringer Ingelheim, Germany) and poly(ethylene-co-vinyl) acetate (Aldrich Chemical Company, Inc., Milwaukee, Wis.) polymers. The concentration of the two polymers dissolved in dichloromethane (Sigma-Aldrich, St. Louis, Mo.) were 0.19 g/ml RESOMER® RG 503 and 0.077 g/m poly(ethylene-co-vinyl) acetate. The electrospinning set-up consists of a glass pipet (overall length approximately 21 cm with a tapered tip with an opening estimated at 0.3 mm, no exact measurement obtained, 0.32 mm diameter silver-coated copper wire, 20×20 mesh 316 stainless steel screen, two large clamp holders (polymeric coated), base support, and a Spellman CZE1000R power supply (0-30,000 volts, Spellman High Voltage Electronic Corp., Hauppauge, N.Y.). The physical set-up had the top clamp holder containing the glass pipet at approximately 12 inches from the base with the pipet tip pointing (pipet at approximately at 45 angle to base) toward the base. The wire was then placed in the top of the glass pipet and inserted until reaching the pipet tip where it remained during the procedure. The second clamp holder was placed at approximately 6 inches above the base for holding the screen (grounded target) approximately perpendicular to the axis of the glass pipet. The distance between the pipet tip and the grounded screen was approximately 10 cm. The positive lead from the high voltage power supply was attached to the wire hanging out the top end of the glass pipet while the negative lead (ground) was attached directly to the stainless steel screen. The glass pipet was then filled with the appropriate solution and the power supply turned on and adjusted until electrospinning was initiated (i.e. fibers shooting from the tip of the glass pipet). This stream (splay) of solution begins as a monofilament which between the pipet tip and the grounded target is converted to multifilaments (electric field driven phenomena). This allows for the production of a “web-like” structure to accumulate at the target site. Upon reaching the grounded target, the multifilaments collect and dry to form the 3-D interconnected polymeric matrix (fabric). The formation of these multifilaments is dependent upon the reaction conditions and polymers in use. Varying the conditions can alter the production of the filament, resulting in a non-woven matrix composed of a single continuous filament. All described studies and solutions are at room temperature. The fibers produced by these preliminary studies ranged from 1-100 microns in diameter with both polymeric solutions evaluated. The thickness of the matrices produced was not measured. Although, the thickness of the matrix that can be produced is dependent on the amount of polymer solution (spinning time) utilized and allowed to accumulate in a particular region. Thus, allowing the ability to produce a matrix with varying thickness across the sample. A scanning electron micrograph of the fiber forming the matrix is shown in FIG. 1.

Electroaerosol Production of A Matrix

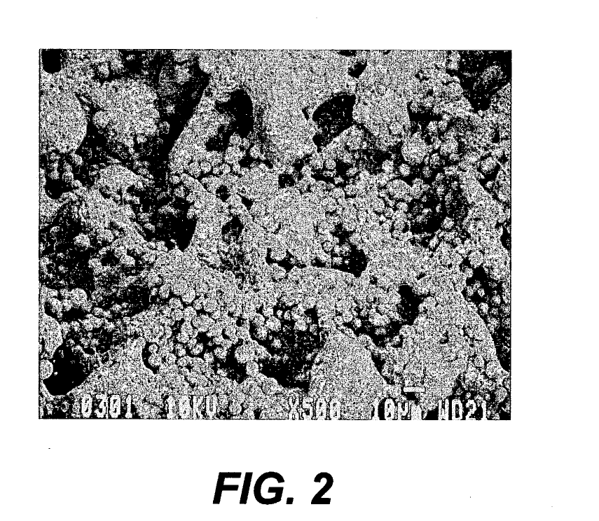

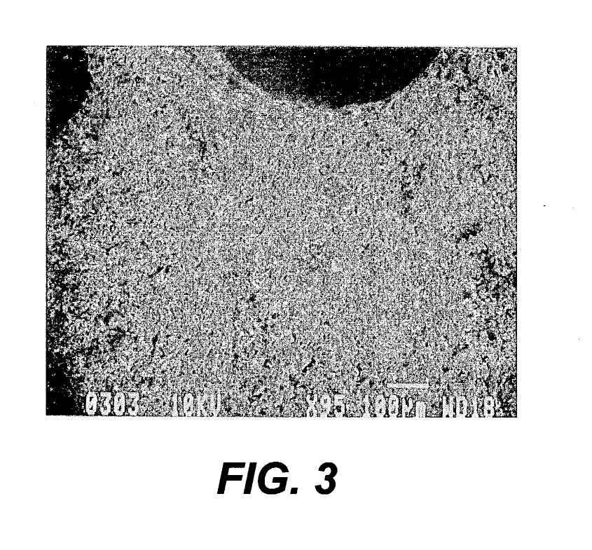

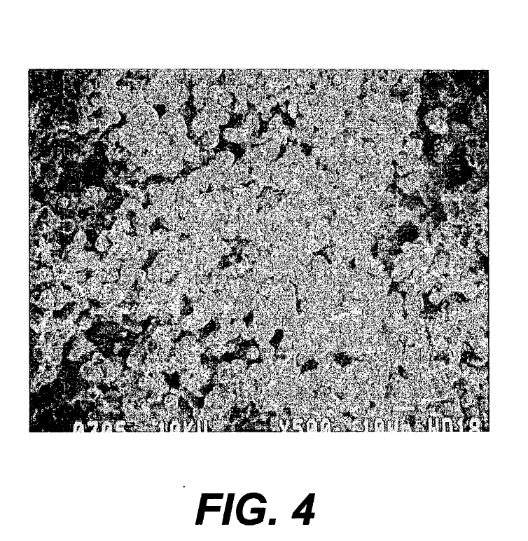

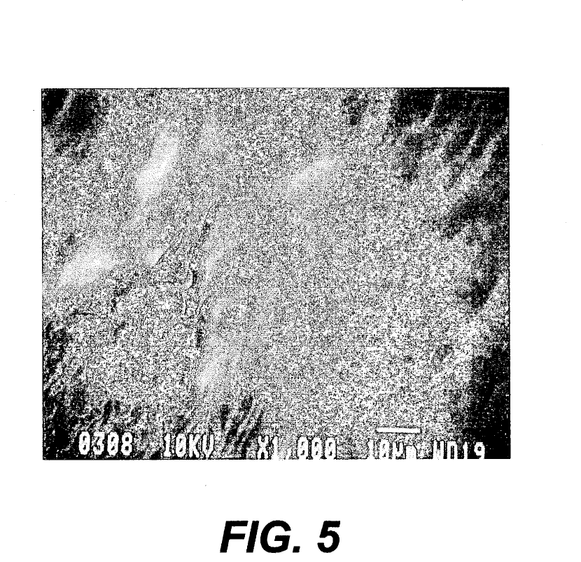

A matrix in the form of a tube was made. Like the electrospinning described in the first example, the electroaerosol process includes a polymer reservoir, spray nozzle and grounded mandrel. In this experiment, the polymer reservoir and spray nozzle was a 1.0 ml syringe (minus plunger) and a simple plastic pipette tip (Gel Loading Tip, Fisher Scientific), respectively. The grounded mandrel was composed of stainless stell needle (18 gauge, length ˜8 cm). Note: Prior to aerosol/matrix production, the mandrel was treated with a hexane solution saturated with Vaseline to allow easy removal of the formed construct from the mandrel. The polymeric solution used was polylactic/polyglycolyic acid (PLA/PGA; 50/50) at a concentration of 0.189 g/ml in methylene chloride. A fine wire was placed into the pipette tip as far as it would go. With this tip, the wire could not pass all the way through, thus approximately a quarter inch of the tip was cut-off at the point where the wire had passed through and became lodged. The wire in this experiment was charged to 12,000 volts (Spellman High Voltage Power Supply). Upon applying the electrical potential, the polymer aerosol began at the pipette tip and was directed towards the grounded mandrel. The aerosol was then collected around the mandrel. A total of 4 ml of the polymeric solution was used to create a matrix. Step one was to fill the reservoir/syringe with 1 ml of polymeric solution, charge the solution and allowing aerosol production. Upon emptying the reservoir, the mandrel was rotated 90 degrees (step 2) and step one was repeated. These steps were then repeated 4 times for the complete construct. FIGS. 2 to 5 are scanning electron micrographs of the matrix produced by this procedure. Mixing an electro aerosol product (droplets or aggregates) with an electrospun product (e.g. fibers or filaments) can be expected to produce unique characteristics. For example, the droplets of elastic components within a matrix of collagen filaments (i.e. leather) could be used to regulate the compression characteristics of the product. This would be useful in a shoe where cushioning would be desirable.

C. Electrospun Shoe and Other Clothing Articles

Solutions of 14.3 w/v % PLA/polycaprolactone in chloroform (65% PLA/35% polycaprolactone polymer blend by weight) were used to create a thin fibrous layer around a small foot mold (American size 8). A previous application of electrospinning noted herein uses a small vascular shaped/sized mandrel, which spins about its axis, to get an even deposition of the fibers. Because the foot mold (mandrel) was so large and heavy, a slow turning pad, which the foot mold was placed on, was used to get the same effect. The next hurdle involved grounding the mold, which is what sets up the electrical attraction between the polymer solution and the foot mold (mandrel) itself. The spinning small vascular shaped/sized mandrel apparatus has a ground insert built into it. To get the same grounded charge on the foot mold, the ground wire was placed between duct tape at either the top or bottom of the foot. To cover the entire foot it took two vials of the polymer solution, which is about 40 ml total. Something else to note is how long it took to cover the foot with a thin matrix. From start to finish, it took about two hours to completely cover the foot with a semi-even deposition. Nike Corporation provided the mold used. This process was greatly accelerated when more than one nozzle was used to electroprocess the materials used to produce the shoe.

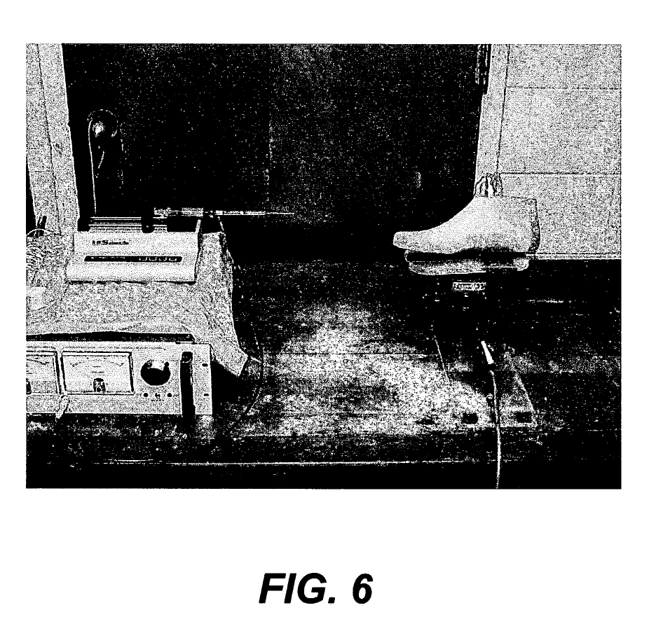

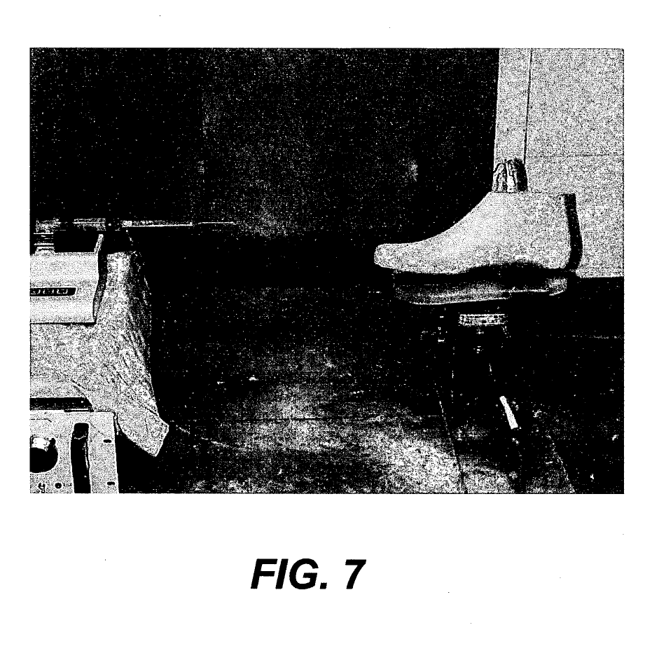

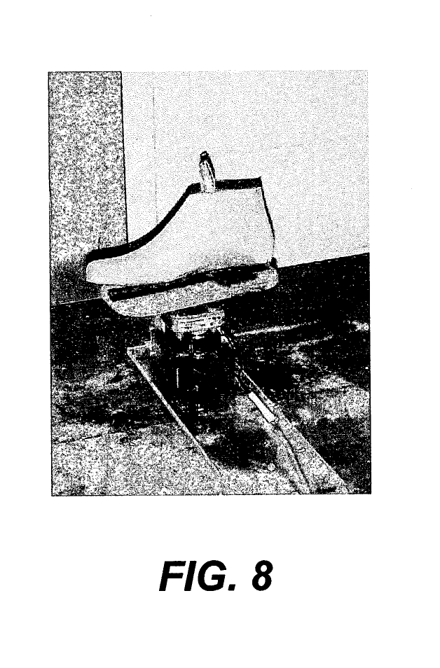

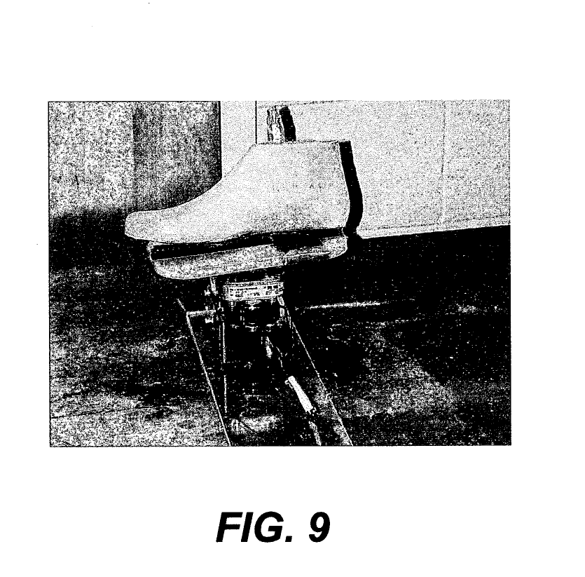

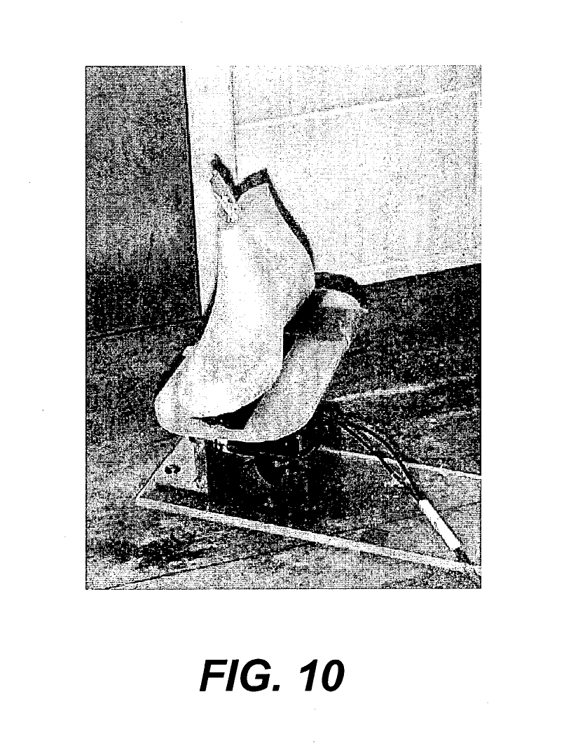

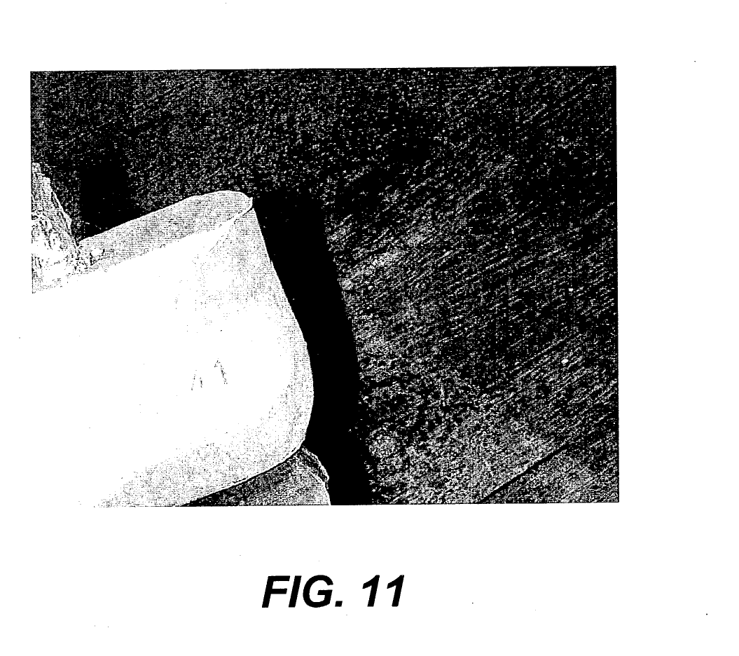

All the above is illustrated in FIGS. 6-11. Specific processing parameters are noted in the earlier applications. Electroprocessing of the materials that were used in these experiments was accomplished in a high voltage field (18,000 to 20,000 kV) with very low current. This has important consequences to the adaptation of this technology to the manufacturing of shoes or clothing. It has been demonstrated in other applications (biomedical) that it is possible to electroprocess materials directly onto living surfaces (i.e. electrospin directly onto people). This is possible because very little current is actually passed during the electroprocessing process. An implication of this observation is that it is theoretically possible to electroprocess a shoe or glove or other piece of clothing directly onto an individual, the ultimate in custom fitting. The final product can be tailored to conform to the individual's own shape. Again, the unique aspects of this processing technique are the precision with which the shoe mold can be covered with the matrix, the ability to make a seamless product and the ability to produce fabrics with custom characteristics (elasticity, water repellent etc.).

D. Color and Electrical Alterations in Electrospun Fabric That are Tension and Compression Sensitive

A variety of different materials can be electrospun to produce seamless fabrics. In this alternative, material that changes color in response to stretch and compression is used to produce various parts or complete elements of a shoe or other clothing article. For example, during running, shoes (and clothing in general) undergo deformations. Materials, such as urethanes and other materials that are sensitive to stretch and compression could be electrospun. During use, as the shoe or other piece of clothing is deformed, its apparent color could be engineered to change in response to that physical deformation. (This phenomenon is known as “mechanochromism”, and several examples, especially with polyurethanes, are known in the literature, although without reference to electroprocessing.) For example, as a person runs and the foot strikes the ground, the mid sole of the shoe might experience more strain than adjacent areas. As a result the perceived color of that portion of the shoe, or other garment, would change. As the distribution of strain and compression changes as the stride changes so too would the color. Similar events can be used to describe how a shirt or other article of clothing made with this type of fabric might change in response to deformation. This type of material could be used exclusively for fashion but also as a diagnostic tool to evaluate strain/compression patterns in clothing or other materials. In the latter case a drape of material could be placed over an object, and as the object deformed and the overlaying material deformed the color of the drape would also change. In another use a more tight fitting cloth might be used to diagnosis movement. For example stockings, similar to pantyhose, could be worn as a person walks to assess leg motion, joint motion etc.

A variation of this idea is to incorporate a piezoelectric material into the fabric during or after spinning. This would allow the material to generate an electric discharge upon compression or stretch. This discharge could be harnessed to produce useful or not so useful work such as lighting up a small series of light bulbs or other devices. The advantage is that the electrical charge would be produced solely by the movement and deformation of the shoe. The generated electrical activity could also be used to detect deformations in objects in much the same way as color changes—as described above. A series of detectors designed to detect small electrical discharges could be arrayed along an electroprocessed surface that had piezoelectric activity. Movements of the electroprocessed materials would generate electric currents, the magnitude of these discharges could be related to the degree of deformation in the object.

E. Built-in Orthotic-like Support System in the Sole of the Shoe.

There exists current technology that allows shoe manufacturers to build in some intrinsic support in the sole of the shoe. This is usually achieved by manufacturing techniques such as building the shoe around certain shoe lasts, addition of skives and utilizing different foam densities in the sole. These techniques only allow for limited individualization in terms of fitting shoes. Additionally, this current methodology is unable to account for the multitude of variations within each category of foot types. By adding a built-in support system that can be customized for a person's foot type would serve to increase the ability to individualize shoes. This idea could be designed so that there would not be any need to make a larger number of models of shoes. This would be dependent on the design strategies. Several different strategies might be envisioned for this product. At present inserts are prescribed and custom designed during office visits to a health professional. The unique aspect of this application is the delivery of the insert at the point of sale in the retail setting.

In one version, this product could be designed with an inflatable air bladder within different areas of the sole. This would allow the technician to place the consumer in a relative neutral position in weight bearing or partial weight bearing and inflate the bladders to give the desired support. This delivery mechanism could be modified to allow for inflation and/or deflation to allow for adjustments to be made either by the technician or the consumer themselves.

Another version of this product might be to have some material that is polymerized with the addition of a catalyst. This material could be imbedded in an envelope within the sole. Then, a nipple or valve apparatus could be connected so that the catalyst could be added at the point of sale to mold to the consumer's foot type. An additional idea is to have a polymer that could be altered after the point of sale to make it adaptable for optimizing comfort.

For dress and casual shoes, the product might be fashioned by similar means; however, the delivery system could be masked in some fashion for example, on the sole of the shoe. This system could be adapted to both men's and women's dress and casual shoes including golf shoes. This would provide a means to enhance comfort and performance in shoes that are worn for a majority of the day. The idea would be that consumers would no longer have to pay for highly priced orthotics to alleviate minor foot problems as well as minimizing the need to purchase multiple sets of inserts designed for specific shoes. In essence it would eliminate the need to interchange the inserts between different shoes. In addition, this system would help maximize foot function in a variety of shoes without compromising comfort.

Orthotic inserts are currently fitted and manufactured by medical personnel (e.g.—Podiatrists, Orthotists, and Physical Therapists) to correct serious foot deformities at high costs. This invention would provide an orthotic-like support system in multiple shoe types (athletic, casual and dress) at a nominal cost for the general population while providing functional advantages in performance. In addition, these built-in support systems in the sole of the shoe could serve as the base for the electrospinning process allowing for a continuation of the seamless shoe concept.

Training of sales people would be difficult, but this could be addressed by offering training videos and/or seminars. Having “certified” fitting personnel at the point of sale could be seen as an additional selling point for the process. Tables, charts or perhaps models could be developed to assist in the fitting process making it more standardized for the fitter while maintaining the individualized fit for the consumer.

Immediate uses could be for athletic shoes to improve performances of athletes at all levels. Long-term uses could be to adapt the technology to other shoe types such as casual and dress shoes to improve comfort while maintaining style

F. Manufactured Leather

Since leather is comprised essentially of collagen, the electroprocessing invention may be used to manufacture a leather product. Complex, seamless leather forms can be fabricated. This fabrication process would utilize the natural polymer collagen in fibrillar form to produce natural leather like products. Electrospinning leather in this fashion will provide a means to make fiber blends to produce novel fabric combinations. Novel fabric combinations could be manufactured to exhibit unique physical properties such as increased elasticity, water resistance/water proofness, increased strength, durability, and selected incorporation of resilient materials for padding and gripping. Additionally, the thickness of the leather fabric can be selected and controlled. This fabrication process further minimizes waste during production of the electrospun leather as well as finding a use for waste natural leather created as a by product of working with natural leather products. Also, utilizing natural products is more environmentally safe.

Still further, the product and process provides a mechanism to mend natural leather or the electrospun leather described herein. The invention therefore minimizes waste resulting from imperfection or tears in natural leather. Additionally, electrospun leather could be combined with natural leather to produce hybrids that would minimize waste by capitalizing on the utilization of scrap materials typically discarded in current production methods.

Seamless materials are more waterproof and less likely to fail than standard seamed leather products. Also, it is possible to produce complex seamless three-dimensional shapes with electroprocessing that precisely fit complex shapes. Another advantage is that all of the leather would be of premium quality. The invention eliminates the need to discard a rawhide because of tears or other imperfections, because the invention fabricates the electrospun leather from the basic collagen fibers that make up leather. The quality of the manufactured leather would be absolutely uniform and dependent upon the selection and choices in the manufacturing process, not the limitations in the raw materials.

Collagen from rawhide, or any other source can be isolated and prepared for electroprocessing. For example, hide can be cut into small pieces, frozen and fragmented into small pieces, lyophilized and used as a crude mixture of raw material for electroprocessing. Other isolation procedures are also possible, i.e., acid hydrolysis or the isolation of collagen to form a gel dispersion. These procedures can be tailored to isolate collagen in a relatively pure form or a crude form (i.e., still mixed with the components elements that make up the hide in its raw state). Acid extracts of collagen may be dialized against other solvents for example water, to prepare the collagen for processing.

The collagen or crude extract can then be suspended in 1,1,1,3,3,3-hexafluoro-2-propanol or another appropriate solvent or suspension. The solution (or suspension) is then placed into a syringe or other source, charged to high voltage and directed at a grounded target. Streams of solvent containing the suspended collagen are directed at the target. As the stream bridges the gap between the source and ground, the collagen undergoes polymerization to form filaments.

As with any electrospinning process, the filament diameter and orientation can be regulated to a high degree by the reaction conditions. Adding other specific materials into the collagen can further modify material properties. For example, adding a natural material like elastin or a synthetic material like rubber can be expected to produce leather with novel elastic properties. Material properties can also be modulated by adding additional materials during the electrospinning process from additional sources (i.e. other syringes). The advantage of this strategy is that filaments of dissimilar properties can be mixed at the molecular level during fabrication, i.e. filaments of separate and distinct properties can be intermingled at the individual filament level. Spinning specific materials in sequence with one another can produce layers of materials. Also, by mixing different types of collagen or collagen that has been manipulated other ways (e.g. added or removed carbohydrates or peptides) in the solution or filament form, different textures or material properties can be achieved. Also, by forming a gradient in the collagen sources, the composition of the final product can be controlled. A collagen gradient would allow the materials to take on multiple mechanical properties within the same panel of fabric to allow the fabric to accomplish complex functions. The gradient may include variable concentrations of collagen and/or variable types of collagen or other polymer or additive. For example, a high concentration of collagen could be used to produce filaments of high mechanical strength. A gradient towards a low concentration of collagen in the source solution would produce less filamentation and more globular material that could provide a soft surface, a gripping surface, or padding.

After electrospinning, further processing can be performed to produce varying colors, textures, scents, and resiliency (i.e. tanning). Cross linking agents (for example gluteraldehyde, UV light or other conventional tanning materials) can be applied to the product at various stages to adjust material properties. Also, there is nothing to prohibit using the final product in more traditional ways, e.g., producing sheets of the manufactured leather fabric to make products with seams.

### Example

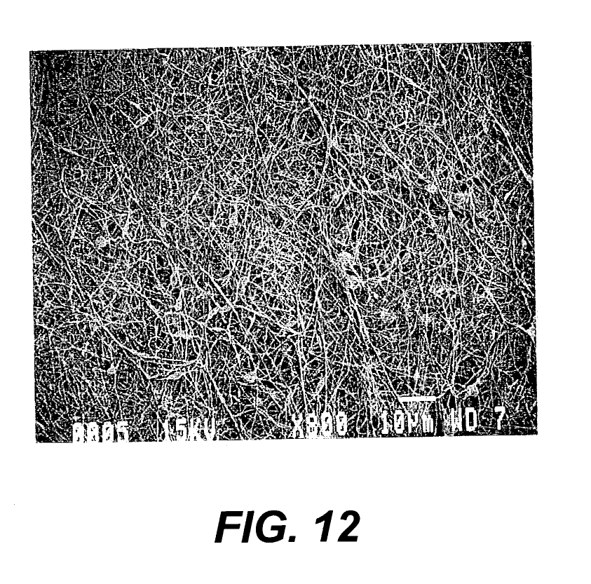

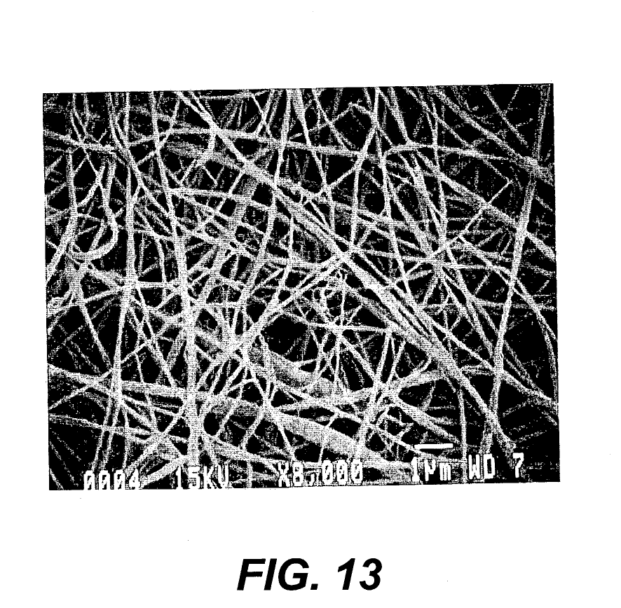

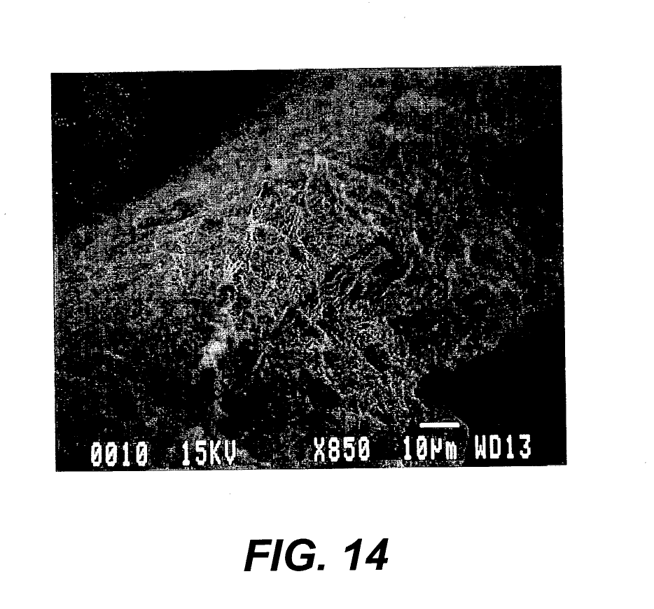

The collagen used was Type I (calf skin, Sigma Chemical Co.). The collagen was suspended in 1,1,1,3,3,3-hexfluoro-2-propanol (HFP) at a concentration of 0.1181 grams in 3 ml HFP. Once in solution or suspension (solution in milky color), the solution was loaded into a 1 ml syringe plunger. A 15-gauge luer stub adapted was then placed on the syringe to act as the electrospinning nozzle and charging point for the contained collagen solution. The filled syringe was placed in the KD Scientific's syringe pump set to dispense the solution at a rate of 18 ml/hr utilizing a Becton Dickinson 1.0-ml syringe plunger. The positive lead from the high voltage supply was attached to the luer stub adapter metal portion. The syringe pump was turned on and the high voltage supply turned on and set at 20 kV. The grounded target was a 303 stainless steel mandrel (0.6 cm W×0.05 cm H×4 cm L) placed approximately 6 inches from the tip of the adapter. The mandrel was rotated at approximately 500 rpm during the spinning process. In the experiment, 1 ml of the collagen solution was electrospun to form a nice, white mat on the grounded mandrel. After electrospinning, the collagen mat was removed from the mandrel and processed for scanning electron microscopy evaluation. The results of this fibrous mat production can be seen in FIGS. 12-14. (Magnification 800×, 8000× and 850× respectively). The mat produced was approximately 200 microns thick.

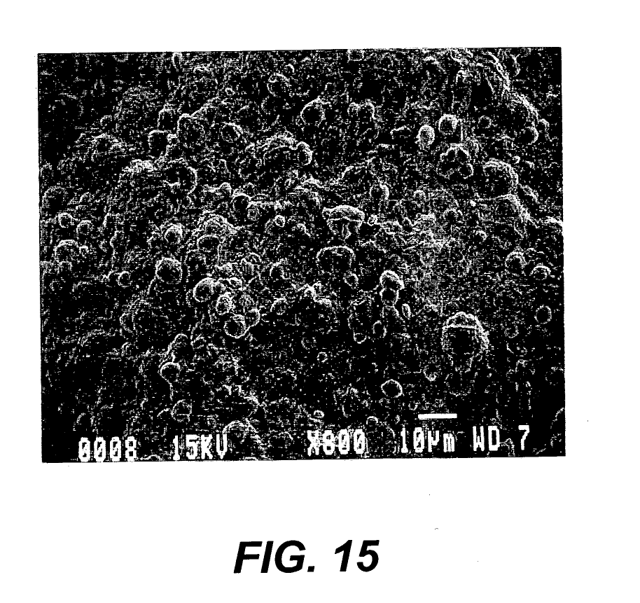

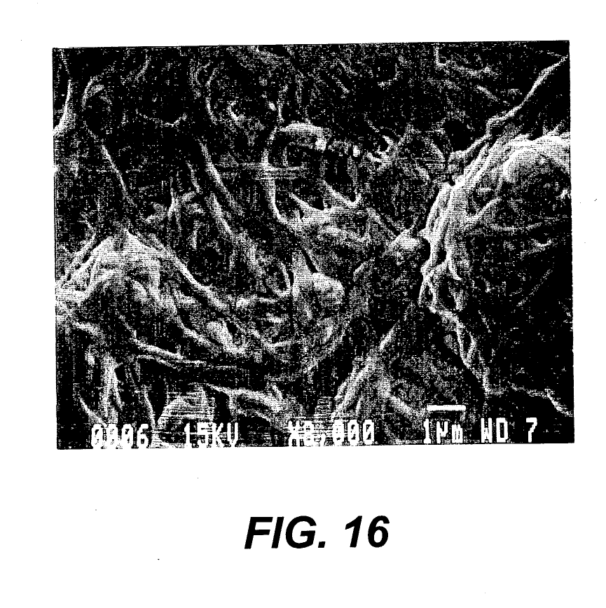

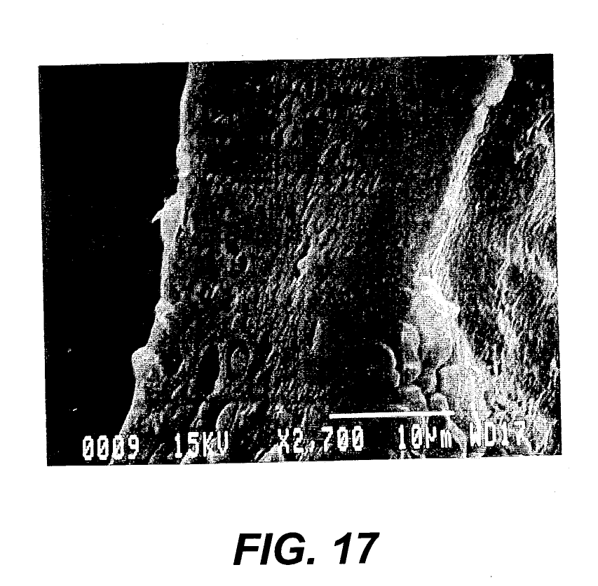

For the production of leather, the collagen mat sample was placed in 2% glutaraldehyde solution (0.1 M sodium cacodylate) for three days (over the weekend). The sample was then placed in 1% osmium tetroxide for 1 to 1.5 hours. The sample was then dehydrated with increasing ethyl alcohol solutions (50-100%). The samples were then sputter coated for viewing on the scanning electron microscope. Results of the fixed sample are shown in FIGS. 15-17. (Magnification 800×, 8000× and 2700× respectively). The figures show a highly cross-linked collagenous mat that is a reproduction of leather.

While the invention has been described with reference to specific embodiments thereof, it will be understood that numerous variations, modifications and additional embodiments are possible, and accordingly, all such variations, modifications, and embodiments are to be regarded as being within the spirit and scope of the invention.

What is claimed is:

1. A shoe having a predetermined shape comprising a matrix of polymer wherein the matrix is formed by electroprocessing the polymer onto a mandrel having the predetermined shape.

2. The shoe described in claim 1, wherein the polymer comprises a material that changes color in response to stretch and compression.

3. The shoe described in claim 2, wherein the material that changes color in response to stretch and compression comprises a polyurethane containing polydiacetylene segments.

4. The shoe described in claim 1, wherein the matrix further comprises piezoelectric material.

5. Clothing having a predetermined shape comprising a matrix of polymer wherein the matrix is formed by electroprocessing the polymer onto a mandrel having the predetermined shape.

6. The clothing described in claim 5, wherein the polymer comprises a material that changes color in response to stretch and compression.

7. The clothing described in claim 6, wherein the material that changes color in response to stretch and compression comprises a polyurethane containing polydiacetylene segments.

8. The clothing described in claim 5, wherein the matrix further comprises piezoelectric material.

9. Manufactured leather comprising a matrix of electroprocessed collagen.

10. The manufactured leather described in claim 24, wherein the collagen comprises electrospun collagen fibers.

11. The manufactured leather described in claim 9, wherein the collagen comprises electrosprayed collagen droplets.

12. The manufactured leather described in claim 9, wherein the electroprocessed collagen is subsequently cross-linked.

13. A method of manufacturing leather comprising electroprocessing a matrix of collagen.

14. The method described in claim 13, further comprising the step of treating the collagen matrix with a cross-linking agent.
